(19) United States
(12) Patent Application Publication
(10) Pub. No.: US 2008/0099559 A1
(43) Pub. Date: May 1, 2008

(54) Dual Interface SIM Card Adapter with Detachable Antenna

(75) Inventors: Ying-Che Lo, Hsinchu (TW); Huan-Chin Luo, Taipei City (TW)

Correspondence Address: MACRONIX;C/O HAYNES BEFFEL & WOLFELD LLP, P. O. BOX 366, HALF MOON BAY, CA, 94019, US

(73) Assignee: Macronix International Co., Ltd., Hsinchu (TW)

(21) Appl. No.: 11/554,733

(22) Filed: Oct. 31, 2006

(51) Int. Cl. G06K 7/06

(52) U.S. Cl. 235/441

(57) ABSTRACT

A dual interface SIM card adaptor is described for use with an existing SIM card slot that provides a dual interface electronic information storage card. The dual interface SIM card carrier comprises a flexible printed circuit board, a mini-sized SIM card, a housing to house the mini-sized SIM card, and a cap to affix the mini-sized SIM card in place. The mini-sized SIM card has dimensions that are less than the dimensions for a typical SIM card. The mini-sized SIM card is separable from a carrier that holds the mini-sized SIM card and an antenna. The adaptor is inserted into the SIM card slot in a mobile handset for contact electronic communication, such as wireless telecom, and for contactless electronic communication, such as public transportation, payment and RFID. Contactless communication can be carried out by RFID, Near Field Communication or bar codes.

### BACKGROUND OF THE INVENTION

1. Background of the Invention

The present invention relates generally to electronic circuit cards, and more specifically to an adaptor for a dual interface electronic information storage card for contact and contactless communications.

2. Description of Related Art

The use of electronic information storage cards such as smart cards has grown rapidly in recent years as mobile devices have increasingly replaced heavier, larger difficult to carry notebook computers, in the lives of people in both industrial and developing countries. This trend is particularly poignant in developing countries like China and India where new infrastructures are built based on the latest technologies in wireless networks instead of on land line systems. The use of mobile handsets in these developing countries has therefore grown by leaps and bounds as the economic growth in these countries has outpaced industrial countries.

Smart cards can be used in a wide range of applications including Subscriber Identification Modules (SIMs) for mobile phones, credit or ATM cards, high-security identification and access-control cards, authorization cards for pay television, public transport and public phone payment cards. SIM cards are widely deployed and used around the world, particularly in countries that run Global System for Mobile Communications (GSM) cellular networks. A SIM card is an integrated circuit card about the size of a postage stamp with embedded integrated circuits. The embedded integrated circuits of the SIM card store information that includes the identification of a mobile phone service subscriber, subscription information, preferences, saved telephone numbers, text messages and other type of information depending on the design.

Two common types of smart cards exist on the market today, “contact” and “contactless” smart cards. The first type of smart card is referred to a “contact smart card” which has a small gold chip for making electrical contacts and another for reading information from the gold chip and for writing information onto the gold chip. The contact smart card has a set of contacts, dimensions and locations that are defined by International Organization Standardization (ISO) 7816-2.

The second type of smart card is referred to as a “contactless smart card” where an integrated circuit chip communicates with a card reader, such as through Radio Frequency Identification (RFID) induction technology. A popular use of the contactless smart card is to process a transaction quickly that is preferably hands-free, such as for use on mass transit systems. The contactless smart card requires close proximity to an antenna. The standard for the contactless smart card communications is defined in ISO 14443.

One problem that has arisen is the presence of blockage on a backside of a mobile handset when communicating between the mobile handset and a contactless reader or writer. A component placed on the backside of the mobile handset, such as a battery, could potentially cause interference during a contactless communication. Accordingly, there is a need to design a dual interface SIM card adaptor for conducting contact and contactless communications.

### SUMMARY OF THE INVENTION

The present invention describes a dual interface SIM card adaptor (or carrier) for use with an existing SIM card slot that provides a dual interface electronic information storage card. The dual interface SIM card carrier comprises a flexible printed circuit board, a mini-sized SIM card, a housing to house the mini-sized SIM card, and a cap to affix the mini-sized SIM card in place. The mini-sized SIM card has dimensions that are less than the dimensions for a typical SIM card. The mini-sized SIM card is separable from a carrier that holds the mini-sized SIM card and an antenna. The adaptor is inserted into the SIM card slot in a mobile handset for contact electronic communication, such as wireless telecom, and for contactless electronic communication, such as for use on public transportation, payment and Radio Frequency Identification (RFID). Contactless communication can be carried out by RFID, Near Field Communication (NFC) or bar codes.

The mini-sized SIM card includes eight contact pads C1 through C8, where the contact pads C4 and C8 are typically not used. In the present invention, the contact pads C4 and C8 are connected to the RF input pads on an integrated circuit chip so as to facilitate contactless communication. In one embodiment, the mini-sized dual interface SIM card has dimensions of about 15 mm in length, about 12 mm in width, and less than 1 mm thickness. In addition, the thickness of the dual interface SIM card carrier is less than 1 mm so that the dual interface SIM card carrier can be inserted in the SIM slot on a mobile handset.

The flexible printed circuit board has a first principal surface that is used to reroute the contact pads of the mini-sized SIM card to the six connecting pins in the SIM slot. The six contact pads on the first principal surface of the flexible printed circuit board for SIM slot connections are denoted as C1-C3 and C5-C7. The flexible printed circuit board has a second principle surface that has eight contact pads, with the addition of contact pads C4 and C8 to the six contact pads, C1-C3 and C5-C7. The contact pads C4 and C8 on the second principal surface of the mini-sized SIM card are used for connecting to the antenna. The flexible printed circuit board has a pair of wires, which connect to the contact pads C4 and C8, for connecting to a connector of an antenna for contactless communication.

The antenna includes a connector that is detachable from the pair of wires from the flexible printed circuit board. Embodiments of the antenna can be manufactured by a wide variety of methods including etched metal lines on a printed circuit board, a wiring coil, or printing conducting wires onto a plastic paper.

Broadly stated, a dual interface card carrier comprises a circuit board having first and second principal surfaces, the first principal surface having a plurality of contacts operating as a first interface for contact communication, the second principal surface having a second plurality of contacts operating as a second interface for contactless communication; a chip card having an inwardly-facing surface with a plurality of contact pads for making electrical contacts with the second plurality of contacts in the second principal surfaces; and a chip housing that houses the chip card.

Advantageously, the present invention describes a dual interface SIM card carrier that prevents a blockage, such as a battery attached on the backside of the handset, for placement between a dual interface card and a contactless reader/writer during contactless communication.

The structures and methods of the present invention are disclosed in the detailed description below. This summary does not purport to define the invention. The invention is defined by the claims. These and other embodiments, features, aspects, and advantages of the technology can be understood with regard to the following description, appended claims and accompanying drawings.

### BRIEF DESCRIPTION OF THE DRAWINGS

The invention will be described with respect to specific embodiments thereof, and reference will be made to the drawings, in which:

FIG. 1A illustrates a perspective view from the bottom of a dual interface SIM card carrier with various components including a chip card having first size dimensions in accordance with the present invention.

FIG. 1B illustrates a perspective view from the top of a dual interface SIM card carrier with various components including the chip card having first size dimensions in accordance with the present invention.

FIG. 2A illustrates top views of stacking the various components in the dual interface SIM card carrier where the dual interface SIM card carrier includes the circuit board, the chip card and the cap in accordance with the present invention.

FIG. 2B illustrates bottom views of stacking the various components in the dual interface SIM card carrier where the dual interface SIM card carrier includes the circuit board, the chip card and the cap in accordance with the present invention.

FIG. 3 illustrates the installation of the dual interface SIM card carrier and accessories into a mobile handset in accordance with the present invention.

FIG. 4 illustrates an alternative embodiment of the dual interface SIM card carrier with a liftable cap in accordance with the present invention.

FIG. 5 illustrates a perspective view of the chip card which is fitted into the chip housing for insertion into the SIM card slot in the mobile handset in accordance with the present invention.

FIG. 6 illustrates an alternative embodiment for connecting the antenna to a chip card via contact pads A1 and A2 in accordance with the present invention.

FIG. 7 is a graphical diagram illustrating one embodiment of sample dimensions of the chip card in accordance with the present invention.

### DETAILED DESCRIPTION

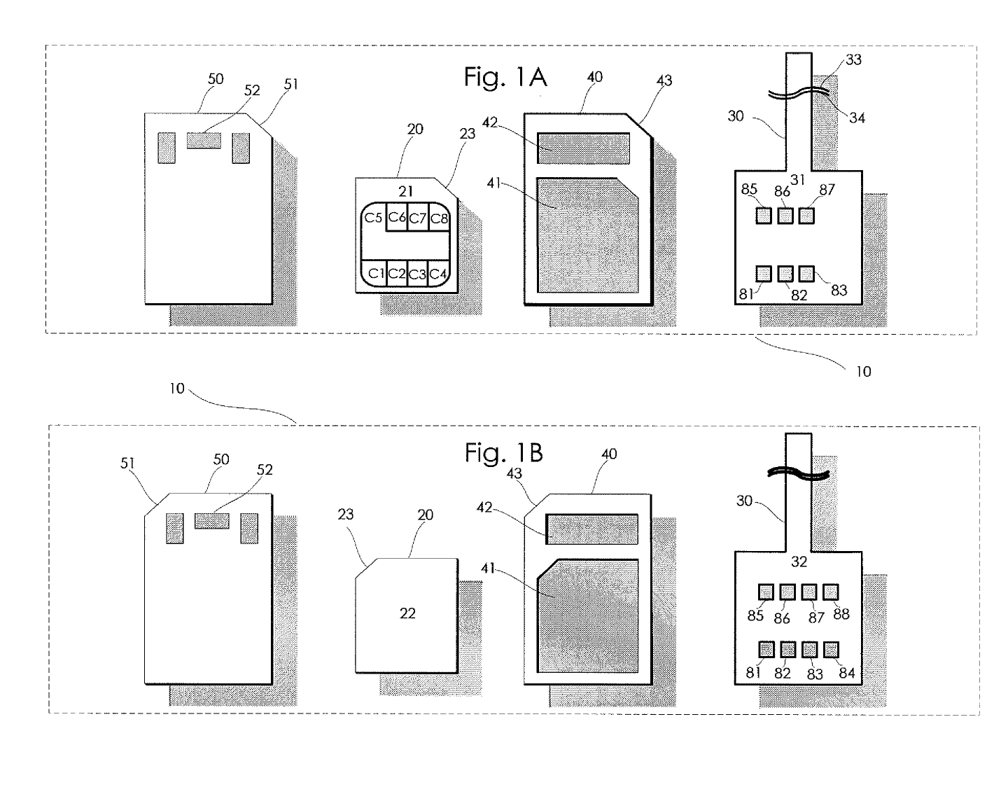

A description of structural embodiments and methods of the present invention is provided with reference to FIGS. 1-5. It is to be understood that there is no intention of limiting the invention to the specifically disclosed embodiments but that the invention may be practiced using other features, elements, methods and embodiments. Like elements in various embodiments are commonly referred to with like reference numerals.

FIGS. 1A-1B illustrate perspective views from the bottom (or bottom views) and perspective views from the top (or top views), respectively, of various components in a dual interface SIM card carrier 10 that includes a chip card 20 having first size dimensions. The dual interface SIM card carrier 10 comprises a circuit board 30, such as a flexible printed circuit board, a housing or chip housing 40 for housing the chip card 10, and a cap 50 that fits over the housing 40 to hold the chip card 20 in a stable position. An exemplary example of the chip card 20 having the first size is a mini-sized dual interface Subscriber Identity Module (SIM) card.

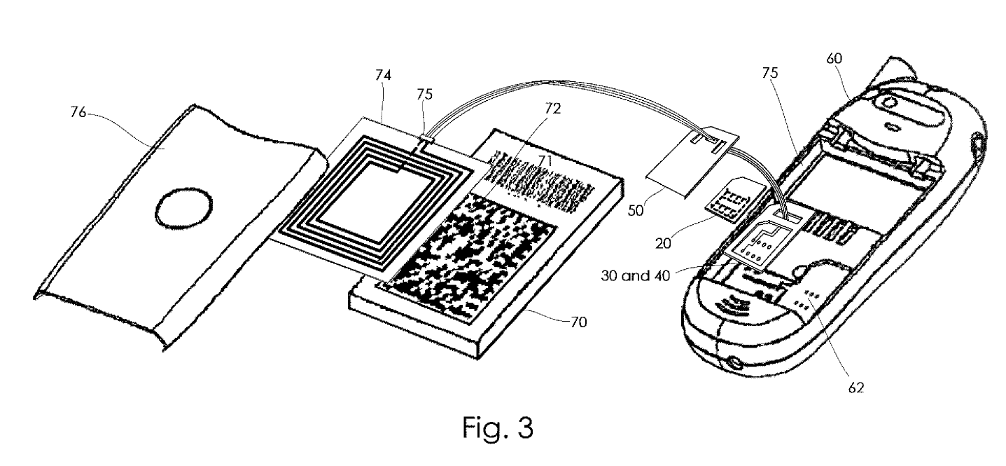

A typical SIM card slot 62 is capable of holding a typical SIM card, which has second size dimensions with a plug-in size of about 25 mm long and 15 mm wide, and less than 1 mm thick. The carrier 10 has a plug-in SIM card size, for example less than 1 mm thick, for insertion into the SIM card slot 62 of a mobile handset 60, as shown in FIG. 3. The chip card 20, such as the mini-sized dual interface SIM card, has first size dimensions that are less than second size dimensions of the typical SIM card. The term “mini-sized” dual interface SIM card refers to the relatively smaller size dimensions of the chip card 20 compared to the typical SIM card. Embodiments of the chip card 20 include first size dimensions of 15 mm long, 12 mm wide, and less than 1 mm thick.

The circuit board 30 has a first principal surface 31 from the bottom view and a second principal surface 32 from the top view. The first principal surface 31 of the circuit board 30 includes six contact pads 81, 82, 83, 85, 86, 87 for making connections in the SIM card slot 62. The six contact pads on the first principal surface of the circuit board 30 correspond to contact pads C1-C3 and C5-C7 on the chip card 20 for making electrical connections. The second principal surface 32 of the circuit board 30 includes eight contact pads, 81, 82, 83, 84, 85, 86, 87, 88, with the addition of contact pads C4 and C8 from the six contact pads, C1-C3 and C5-C7. The contact pads C4 and C8 on the second principal surface of the chip card 20 are used for connecting to a connector or port of an antenna 74, as shown in FIG. 3. The circuit board 30 further includes a pair of routing wires (C4 and C8) 33, 34 that are sufficiently long to bypass a blockage, such as a battery on the back side of the handset, and are connected to the antenna 74 for contactless communication.

The chip housing 40 has a first slot 41 for holding the chip card 20 and a second slot 42 for routing wires through the chip housing. The first slot 41 is provided for placing the chip card 20 in the chip housing 40. A corner 23 of the first slot 41 is cut at an angle to ensure correct orientation when the chip card 20 is placed in the first slot 41. The chip card 20 can be inserted in the first slot 41 with the angled corner 23 with the correct orientation.

The chip card 20 has an inwardly-facing surface 21 with a plurality of contact pads 1-8 (C1-C8) and an outwardly-facing surface 22. The inwardly-facing surface 21 of the chip card 20 includes eight contact pads, C1 through C8. The eight contact pads C1 through C8 are specified and defined in accordance with a smart card standard of the ISO 7816-2. The following table contains the contact pads definition according to ISO 7816-2.

TABLE 1

| Contact Pad | Designation | Description |
|---|---|---|
| C1 | Vcc | Power connection |
| C2 | RST | Reset line |
| C3 | CLK | Clock signal line |
| C4 | RFU | Reserved for future use |
| C5 | GND | Ground line |
| C6 | Vpp | Programming power connection |
| C7 | I/O | Input/output line that provides a |
| | | half-duplex communication channel between |
| | | the reader and the smart card |
| C8 | RFU | Reserved for future use |

The contact pads C1, C2, C3, C8, C6, C7 have been assigned as interface pins for use with the functions as described in Table 1. Two of the contact pads, C4 and C8, are listed as reserved for future use. In the present invention, the contact pads C4 and C8 are used as RF input pads of the chip card 20, which is an integrated circuit chip. The contact pads C4 and C8 are connected to the antenna 74, as shown in FIG. 3, thereby providing contactless communication such as publication transportation, mobile payment, RFID and other types of contactless communication.

The cap 50 includes a corner 51 that is cut at an angle for matching correct orientation with a corner of the chip housing 40 that is also cut when placing the cap over the chip housing 40. The chip card 20 can be inserted in the first slot 41 with the angled corner 23 in the correct orientation. The cap 19 includes a through-hole 19 for passing a wire through the cap 50. The cap 50 further includes a through hole 52 for passing through the pair of wires 33, 34 through the cap 50.

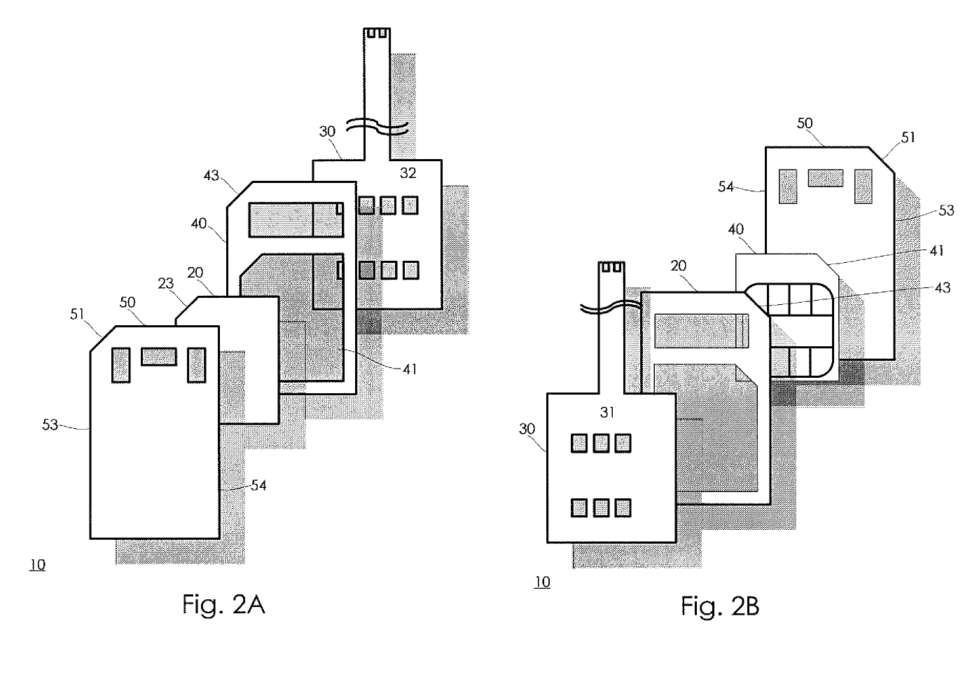

FIG. 2A illustrates top views of stacking the various components in the dual interface SIM card carrier 10 where the dual interface SIM card carrier 20 includes the chip card 20, the circuit board 30, the chip housing 40 and the cap 50. Each of the components, the circuit board 30, the chip housing 40, the chip card 20, and the cap 50 are shown with the surfaces and dimensions as viewed from the top. The top view of the circuit board 30 shows the second principal surface 32 with eight contact pads, 81, 82, 83, 84, 85, 86, 87, 88. The top view of the chip housing 40 shows the first slot 41 and the chip housing disposed over the circuit board 30. The chip card 20 is placed in the first slot 41 of the chip housing 40 with correct orientation by matching the angled corner 23 of the chip card with the angled corner 43 of the chip housing. The cap has ledges 53, 54 that are placed over the side surfaces of the chip housing 40 to securely hold the chip card 20 in the housing 40. The cap 50 also has the angled corner 51 that matches with the angled corner 43 of the housing 40 to ensure correct orientation.

FIG. 2B illustrates bottom views of stacking the various components in the dual interface SIM card carrier 10 where the dual interface SIM card carrier 10 includes the chip card, the circuit board 30, the chip card 40 and the cap 50. Each of the components, the circuit board 30, the chip housing 40, the chip card 20, and the cap 50 are shown with the surfaces and dimensions as viewed from the bottom. When viewing from the bottom, the first component encountered is the circuit board 30, the second component encountered is the chip housing 40, the third component encountered is the chip card 20, and the fourth component encountered is the cap 50. The bottom view of the circuit board 30 shows the first principal surface 31 with six contact pads, 81, 82, 83, 85, 86, 87. The bottom view of the chip housing 40 shows the first slot 41 and the chip housing disposed over the circuit board 30. The chip card 20 is placed in the first slot 41 of the chip housing 40 with correct orientation by matching the angled corner 23 of the chip housing 40 with the angled corner 43 of the chip housing. The cap has ledges 53, 54 that are placed over the side surfaces of the chip housing 40 to securely hold the chip card 20 in the housing 40. The cap also has the angled corner 51 that matches with the angled corner 43 of the housing 40 to ensure correct orientation.

FIG. 3 illustrates the installation of the dual interface SIM card carrier and accessories into a mobile handset 60. The mobile handset 60 includes the SIM card slot 62 with dimensions suitable for placement of a typical SIM card. The mobile handset 60 as used herein includes, but is not limited to, cell phones, personal digital assistants (PDA), mobile music players, and other types of mobile devices. The first principal surface 31 of the circuit board 30 has six pins facing the SIM card slot 62 and making electrical contacts in the SIM card slot 62. The second principal surface 32 of the circuit board 30 has eight pins facing the chip card 20 and making electrical contacts with the eight contact pads, C1-C8, of the chip card 20. The circuit board 30 and the chip housing 40 are inserted into the SIM card slot 62 of the mobile handset 60. The chip card 20 is inserted into the first slot 41 of the housing 40. The cap 50 is disposed over the chip housing 40 to hold the chip card 20 securely. A battery 70 is placed over the cap 50 and into the mobile handset 60. The antenna 74 is attached to a back surface 71 of the battery 70.

The antenna 74 includes a connector 75 for connecting to the pair of routing wires 33, 34 extending from the circuit board 30. The pair of routing wires 33, 34 are also referred to as an extended tail that is sufficiently long to extend in a circuitous manner as to bypass the blockage, such as the battery 72, on the back side of the mobile handset 60. The antenna 74 is detachable from the extended tail or the pair of wires 33, 34 that is extended from the circuit board 30. Manufacture of the antenna 74 can be carried out using a wide variety of techniques, including etched metal lines on a printed circuit board or a wiring coil, or printing conducting wires on plastic paper. A cover 76 is placed over the antenna 74 and fitted into an open area 75 in the back of the mobile handset 60.

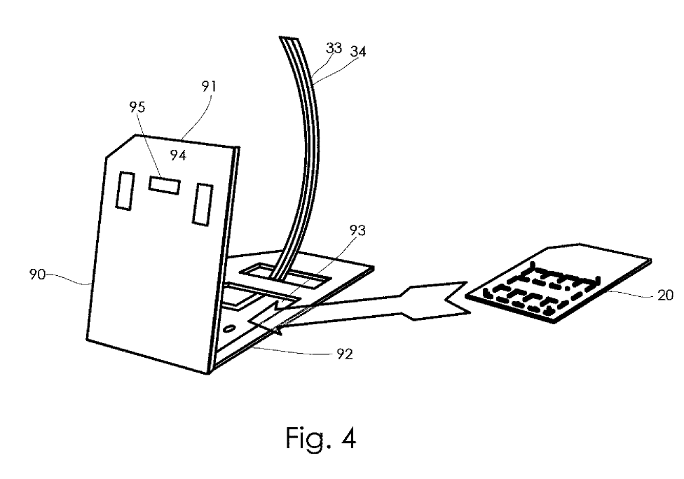

FIG. 4 illustrates an alternative embodiment of a dual interface SIM card carrier 90 with a liftable cap 91. The dual interface SIM card carrier 90 includes a chip housing 92 that is attached to the liftable cap 91. The liftable cap 91 allows the chip card 20 to be placed in a slot 93 of the chip housing 82. The liftable cap 91 has a surface 94 with a through hole 95 for passing through the pair of wires 33, 34.

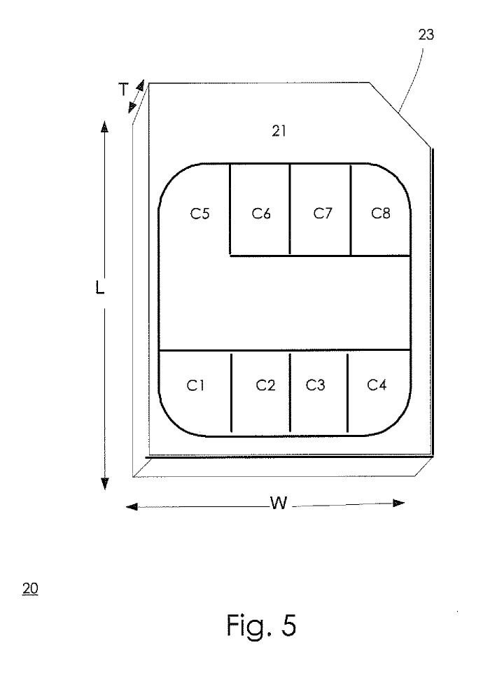

FIG. 5 illustrates a perspective view of the chip card 20 which is fitted into the chip housing 40 for insertion into the SIM card slot 62 in the mobile handset 60. The chip card 20 comprises a mini-sized SIM card that is relatively smaller in size than a regular SIM card. The chip card 20 includes three dimensional values, a first dimensional value L of about 15 mm, a second dimensional value W of about 12 mm, and a third dimensional value T of less than 1 mm. These dimensional values are intended as one embodiment of the present invention. Other dimensions of greater than or less than each of the three dimensional values L, W, and T can be practiced without departing from the spirit of the present invention.

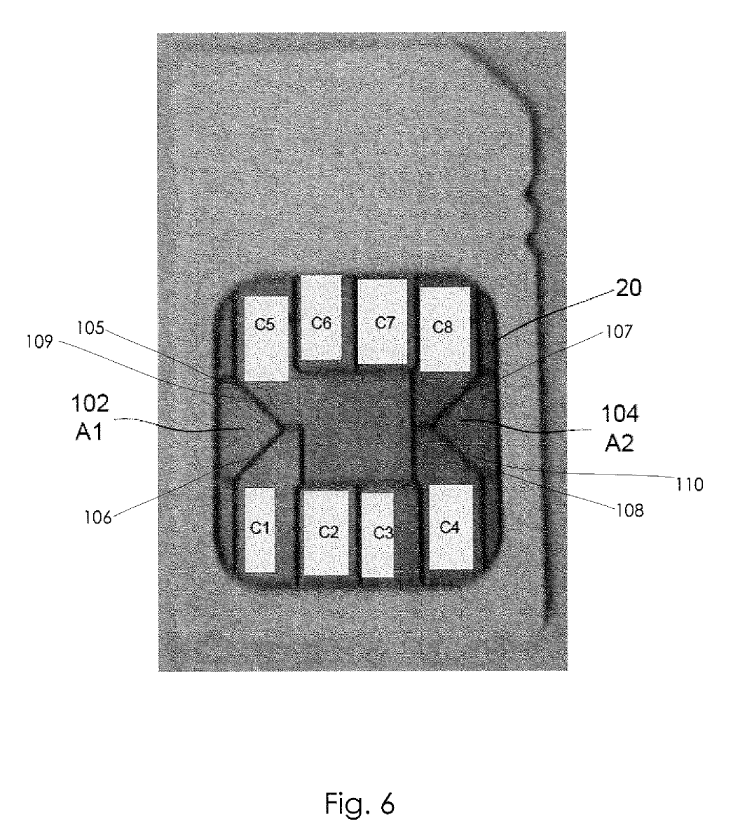

FIG. 6 illustrates an alternative embodiment for connecting the antenna 74 to a chip card 100 via contact pads A1 and A2. Embodiments of the chip card 20 can have configurations as shown in the chip card 20 in FIG. 5 or in the chip card 100 in FIG. 6, which are applicable to FIGS. 1 through 4. The additional contact pads A1 102 and A2 104 provides two connecting sources on the chip card 100 for connecting to the antenna 74 through the pair of wires 33, 34. Each of the contact pads A1 102 and A2 104 has a triangular roof top formed by lines 105, 106, and formed by lines 107, 108, respectively. The line 105 of the contact pad A1 102 is an uninterrupted line, unlike a conventional SIM card that has a gap 109 along the line 105. Therefore, the contact pad A1 102 forms a first geometric shape with uninterrupted lines on the inwardly-facing surface 21 of the chip card 20. Similarly, the line 108 of the contact pad A2 104 is an uninterrupted line, unlike a conventional SIM card that has a gap 110 along the line 108. Therefore, the contact pad A2 104 forms a second geometric shape with uninterrupted lines the inwardly-facing surface 21 of the chip card 20. The first and second geometric shapes can be designed with a wide variety of shapes. In this embodiment, the first and second geometric shapes resemble a rotated house with a large triangular roof top with short sides.

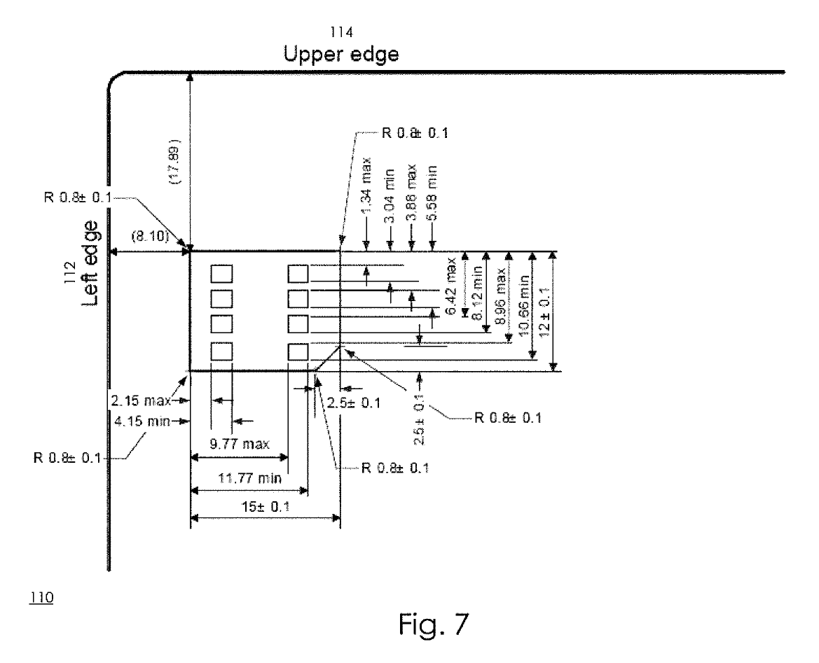

FIG. 7 illustrates one embodiment of a graphical diagram 110 showing sample dimensions of the chip card 20 or 100. The size of the chip card 20 or 100 as show in the graphical diagram 110 includes a length L of about 15 mm and a width W of about 12 mm. Measurements of the contact pads are also illustrated in FIG. 7. The distance between side walls of the chip card 20 or 100 from a left edge 112 and an upper edge 114 are also shown. These parameters provide a set of exemplary sizes of the chip card 20 or 100. Other variations and modifications from the suggested dimensions can be practiced without departing from the spirits of the present invention.

The invention has been described with reference to specific exemplary embodiments. Various modifications, adaptations, and changes may be made without departing from the spirit and scope of the invention. Accordingly, the specification and drawings are to be regarded as illustrative of the principles of this invention rather than restrictive, the invention is defined by the following appended claims.

We claim:

1. A dual interface card carrier, comprising:
a circuit board having first and second principal surfaces, the first principal surface having a plurality of contacts operating as a first interface for contact communication, the second principal surface having a second plurality of contacts operating as a second interface for contactless communication;
a chip card having an inwardly-facing surface with a plurality of contact pads electrically contacting with the second plurality of contacts in the second principal surfaces; and
a chip housing that houses the chip card.

2. The carrier of claim 1, wherein the first plurality of contacts in the first principal surface of the circuit board comprises six contacts (C1-C6) that face a chip card slot and make electrical contacts in the chip card slot.

3. The carrier of claim 1, wherein the second plurality of contacts in the second principal surface of the circuit board comprises eight contacts for electrically connecting to eight contact pads (C1-C8) of the first chip, the two contact pads (C4 and C8) operating as RF signal pads and connecting to two contacts in the second principal surface of the circuit board, the two contacts in the second principal surface connecting to a connector of a detachable antenna.

4. The carrier of claim 1, wherein the chip card has dimensions of about 15 mm long, 12 mm wide and less than 1 mm thick.

5. The carrier of claim 1, wherein the chip card comprises a mini-sized dual interface SIM card that has dimensions less than a SIM card.

6. The carrier of claim 1, wherein the circuit board comprises a flexible printed circuit board.

7. A mobile handset, comprising:
a card carrier, including:
a circuit board having first and second principal surfaces, the first principal surface having a first plurality of contacts operating as a first interface for contact communication, the second principal surface having a second plurality of contacts operating as a second interface for contactless communication;
a chip card having an inwardly-facing surface with a plurality of contact pads for making electrical contact with the second plurality of contacts in the second principal surfaces; and
a chip housing that houses the chip card.

8. The handset of claim 7, wherein the first plurality of contacts in the first principal surface of the circuit board comprises six contacts that face a chip card slot and make electrical contact in the chip card slot.

9. The handset of claim 7, wherein the second plurality of contacts on the second principal surface of the circuit board comprises eight contacts for electrically connecting to eight contact pads (C1-C8) of the first chip card, the two contact pads (C4 and C8) operating as RF signal pads and connecting to two contacts in the second principal surface of the circuit board, the two contacts in the second principal surface connecting to a port of a detachable antenna.

10. The handset of claim 9, wherein the circuit card comprises a pair of wires that are sufficiently long to bypass blockage to the chip card during contactless communication, the pair of wires being electrically connected to the two contacts in the second plurality of contacts on the second principal surface of the circuit board which are connected to the two contact pads (C4 and C8) of the first chip card.

11. The handset of claim 10, wherein the detachable antenna has an input connector for connecting to the pair of wires of the circuit card, and receives RF signals.

12. The handset of claim 11, further comprising a battery disposed between the first chip card and the antenna, the battery having a back side surface with a recess area for placement of the antenna.

13. The handset of claim 11, further comprising a cap for placement over an outwardly-facing surface of the chip card, the cap having a through-hole for passing the pair of wires from the circuit board through the cap and to the detachable antenna.

14. The handset of claim 7, wherein the chip card has dimensions of about 15 mm long, 12 mm wide and less than 1 mm thick.

15. The handset of claim 7, wherein the chip card comprises a mini-sized dual interface SIM card that has dimensions less than a SIM card.

16. The handset of claim 7, wherein the circuit board comprises a flexible printed circuit board.

17. The handset of claim 7, wherein the chip card comprises a first antenna contact pad (A1) and a second antenna contact pad (A2), the first and second antenna contact pads operating as RF signal pads for connecting to a connector of a detachable antenna.

18. The handset of claim 7, wherein the chip card comprises a first antenna contact pad (A1) and a second antenna contact pad (A2), the first antenna contact pad formed a first geometric shape with uninterrupted lines on the inwardly-facing surface of the chip card, the second antenna contact pad formed a second geometric shape with uninterrupted lines on the inwardly-facing surface of the chip card.
